(19) United States
(12) Patent Application Publication
(10) Pub. No.: US 2007/0139761 A1
(43) Pub. Date: Jun. 21, 2007

(54) Light source for wavelength conversion

(75) Inventors: Sun-Lyeong Hwang, Suwon-si (KR); Jung-Kee Lee, Hwaseong-si (KR); Sung-Soo Park, Suwon-si (KR); Du-Chang Heo, Suwon-si (KR); Byeong-Hoon Park, Yongin-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/641,216

(22) Filed: Dec. 19, 2006

(30) Foreign Application Priority Data
Dec. 19, 2005 (KR) 2005-125393

(51) Int. Cl. G02F 1/35

(52) U.S. Cl. 359/328

(57) ABSTRACT

A light source for wavelength conversion which can control gray scale includes a semiconductor laser including at least two radiators, to which different gray scale levels are allocated. Further included is a second-harmonic generator for performing wavelength conversion on lights radiated from the radiators, and outputting the wave-converted lights.

### CLAIM OF PRIORITY

This application claims the benefit under 35 U.S.C. 119(a) of an application entitled “Light Source for Wavelength Conversion,” filed in the Korean Intellectual Property Office on Dec. 19, 2005 and assigned Serial No. 2005-125393, the entire contents of which are incorporated herein by reference.

### BACKGROUND OF THE INVENTION

1. Field of the Invention

The present invention relates to a semiconductor laser, and more particularly to a semiconductor laser including a second harmonic generator.

2. Description of the Related Art

The image display units of recent digital image displayers feature a semiconductor laser capable of representing the three colors green, red and blue.

Although the semiconductor laser can directly modulate red and blue, it is not easy for the semiconductor laser to directly modulate green.

As an alternative, a light source for wavelength conversion can be realized in a direct modulation scheme. The light source includes a semiconductor laser having high-speed modulation characteristics capable of generating infrared light, and further includes a nonlinear second-harmonic generator. A modulation characteristic of the light source is superior to that of the conventional solid-state laser (YAG or YVO4). This allows the light source for wavelength conversion to be applied without a separate external modulation device in various fields, such as display, that require high-speed modulation.

The wavelength conversion efficiency of the second-harmonic generator, which is a wavelength conversion element, is influenced by various factors. It is particularly influenced by change in the wavelength of the light inputted for wavelength-conversion.

It has therefore been suggested that the light source for wavelength conversion include a second-harmonic generator for enabling direct modulation. This type of generator can compensate for the chirp characteristic of light by using a Distributed Bragg mirror (DBR) laser as a semiconductor laser, in order to obtain high-efficiency wavelength conversion characteristics.

In addition, a light source for wavelength conversion using a vertical-extended-cavity surface-emitting laser (VECSEL) has been proposed, but the light source using the VECSEL must further include a separate external oscillator in addition to a laser diode (LD) for pumping. The drawbacks include complicated structure, large size, and low efficiency.

In order to allow the semiconductor laser to perform a modulation operation, the light source for wavelength conversion can control current applied to the semiconductor laser and gray scale, which may be a level of a green light generated according to modulation steps.

The conventional light source for wavelength conversion realizes a change in the gray scale of color by controlling the intensity of current applied upon the modulation operation of the semiconductor laser; however, the wavelength of infrared light generated from the semiconductor laser changes non-linearly due to the change of current. In particular, a change in the wavelength of an infrared light degrades the conversion efficiency of the second-harmonic generator, and a rapid current change causes a change in the temperature of the semiconductor laser.

### SUMMARY OF THE INVENTION

The present invention has been made to solve the above-mentioned problems occurring in the prior art, and, in one aspect, the present invention provides a direct-modulation type light source for wavelength conversion which can control gray scale.

It is accordingly herein proposed to provide a light source for wavelength conversion that can control gray scale. The light source for wavelength conversion includes a semiconductor laser having at least two radiators, to which different gray scale levels are allocated. The light source features a second-harmonic generator for performing wavelength conversion on light beams radiated from the radiators, and outputting the wave-converted light beams.

### BRIEF DESCRIPTION OF THE DRAWINGS

The above and other aspects, features and advantages of the present invention will be more apparent from the following detailed description taken in conjunction with the accompanying drawings, in which:

FIG. 1 is a perspective view of an exemplary light source for wavelength conversion according to a first embodiment of the present invention;

FIG. 2 is a top view of the light source shown in FIG. 1;

FIG. 3 is a perspective view of an exemplary light source for wavelength conversion according to a second embodiment of the present invention;

FIG. 4 is a top view of the light source shown in FIG. 3;

FIGS. 5 and 6 are graphs for explaining the operational state of the semiconductor laser incorporating with gray scale according to the present invention; and

FIG. 7 is a graph for explaining the operational characteristic of a second-harmonic generator.

### DETAILED DESCRIPTION

In the discussion to follow, detailed description of known functions and configurations incorporated herein is omitted for conciseness and clarity of presentation.

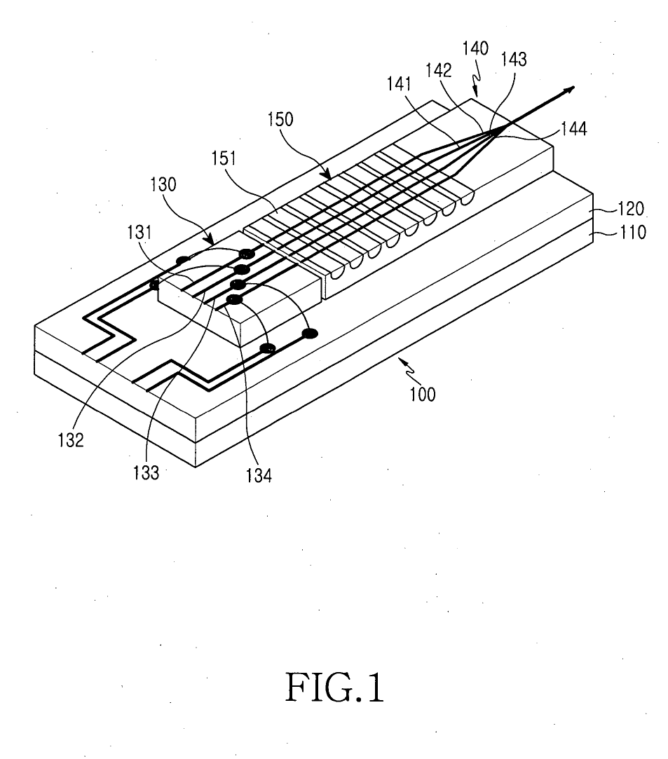

FIG. 1 shows, by way of illustrative and non-limitative example, a light source for wavelength conversion according to a first embodiment of the present invention. The light source 100 for wavelength conversion, which can control gray scale, includes a semiconductor laser 130, a second-harmonic generator 150, and an optical system 140. The semiconductor laser 130 includes at least two radiators 131 to 134, to which different gray scale levels are allocated. The second-harmonic generator 150 performs an wavelength conversion operation with respect to each light radiated from each radiator 131, 132, 133, 134, and outputs the wavelength-converted lights. The optical system 140 includes, as a waveguide portion, waveguides 141 to 144 extended from the second-harmonic generator 150. The gray scale represents the level of brightness. Specific pixels, e.g., on a display screen (not shown), are controlled based on the level of brightness outputted by the optical system 140.

The light source 100 for wavelength conversion is constructed such that a sub-mount 120 is disposed on a cooling unit 110, and the semiconductor laser 130, second-harmonic generator 150 and optical system 140 are disposed on the sub-mount. The cooling unit 110 may include a thermoelectric cooling element.

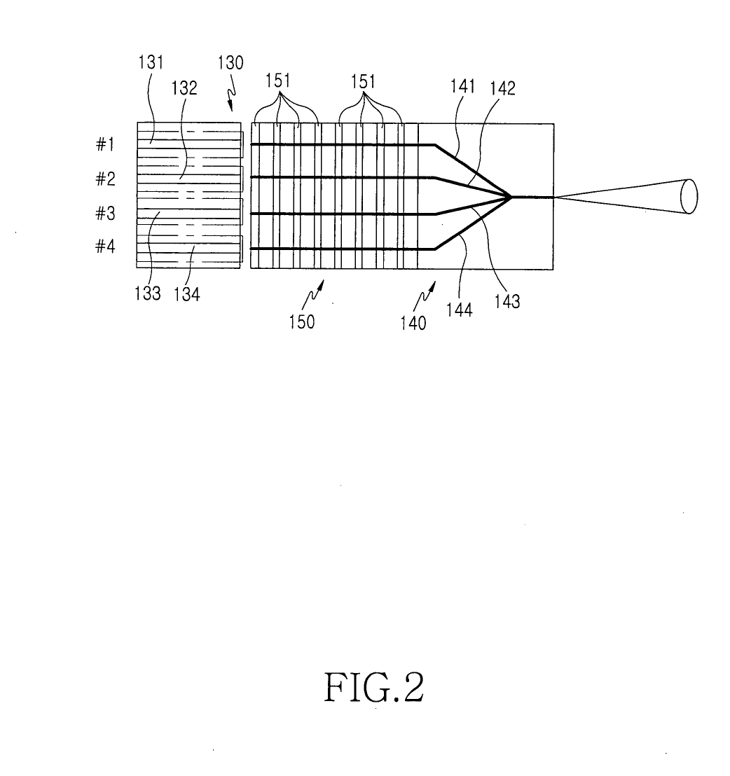

FIG. 2 is a top view of components shown in FIG. 1.

The number of radiators 131 to 134 included in the semiconductor laser 130 may be determined based on the entire gray scale to be achieved by the light source 100 for wavelength conversion. For instance, when it is necessary to achieve 16 gray scale levels with 4 bits, the semiconductor laser 130 may include four radiators 131 to 134 as described according to the first embodiment of the present invention. In this case, the first radiator 131 may be allocated with a first gray level, the second radiator 132 may be allocated with a second gray level, the third radiator 133 may be allocated with a third gray level, and the fourth radiator 134 may be allocated with a fourth gray level. The first through fourth gray levels can be configured to collective cover a range of gray levels, in the same sense the four bit positions in a binary string of length four collectively cover a range of length 16. An example of how this is done is provided immediately below.

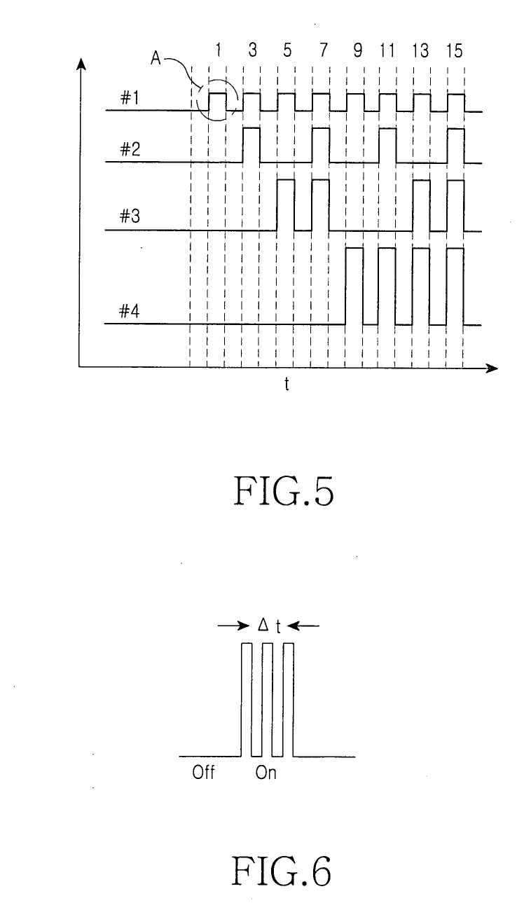

FIGS. 5 and 6 are graphs for explaining the operational state of the semiconductor laser incorporating gray scale, according to the present invention. As shown in FIGS. 5 and 6, the first to fourth radiators operate in a digital scheme based on predetermined current and a modulation circuit (note shown) providing input to the light source 100. In particular, each of the radiators 131 to 134 turns on or off a light having a predetermined gray scale level in a digital scheme according to instructions. The light source 100 for wavelength conversion can create a light having a desired gray scale by combining light beams generated by the radiators 131 to 134. Thus, referring to FIG. 5, the respective gray scale levels turned on, at a given time, additively combine when they converge to produce the output of the light source 100. Accordingly, at instant 7, the first three radiators are radiating light at respective gray scale levels 1, 2, and 8. The fourth radiator is not radiating at instant 7. A total gray level of 1+2+4=7 is therefore achieved upon convergence in the optical system 140.

Table 1 shows combinations for obtaining 16 gray scale levels by using the radiators 131 to 134. As seen from Table 1, any arbitrary gray scale level in the range from 1 to 16 is achievable by its unique combination of gray scales levels associated with the radiators. In general, for N gray scale levels, log₂ (N) radiators are needed.

TABLE 1

| | | Gray Scale Level | | | | | | | | | | | | | | | |
|---|---|---|---|---|---|---|---|---|---|---|---|---|---|---|---|---|---|
| Radiator | Power | 1 | 2 | 3 | 4 | 5 | 6 | 7 | 8 | 9 | 10 | 11 | 12 | 13 | 14 | 15 | 16 |
| #1 | 1 mV | 0 | 1 | 0 | 1 | 0 | 1 | 0 | 1 | 0 | 1 | 0 | 1 | 0 | 1 | 0 | 1 |
| #2 | 2 mV | 0 | 0 | 2 | 2 | 0 | 0 | 2 | 2 | 0 | 0 | 2 | 2 | 0 | 0 | 2 | 2 |
| #3 | 4 mV | 0 | 0 | 0 | 0 | 4 | 4 | 4 | 4 | 0 | 0 | 0 | 0 | 4 | 4 | 4 | 4 |
| #4 | 8 mV | 0 | 0 | 0 | 0 | 0 | 0 | 0 | 0 | 8 | 8 | 8 | 8 | 8 | 8 | 8 | 8 |
| | | 0 mV | 1 mV | 2 mV | 3 mV | 4 mV | 5 mV | 6 mV | 7 mV | 8 mV | 9 mV | 10 mV | 11 mV | 12 mV | 13 mV | 14 mV | 15 mV |

The last row represents the power, in millivolts (mV) at a given amperage. Each power reading corresponds to the total gray level, i.e., level of brightness, at that instant.

The optical system 140 is extended from the second-harmonic generator 150. The optical system 140 converges light beams having different, respective gray scale levels. The lights have been generated from the first to fourth radiators 131 to 134 and have been subjected to wavelength conversion by the second-harmonic generator 150. The converted light is converged into a single light beam for output.

The optical system 140 has one output port and a plurality of input ports corresponding to the first to fourth radiators 131 to 134, and includes a plurality of waveguides 141 to 144 connecting the input ports to the output port.

The second-harmonic generator 150 includes a plurality of polarization-reversal regions 151. The second-harmonic generator 150 performs a wavelength conversion operation with respect to the lights having different gray scale levels, which have been generated from the first to fourth radiators 131 to 134, and outputs the wavelength-converted lights to the optical system 140.

Advantageously, desired gray scale is achieved through combination of lights generated from the radiators 131 to 134, thereby preventing current from being rapidly changed during a converting operation and preventing chirp from occurring due to the rapid change of current.

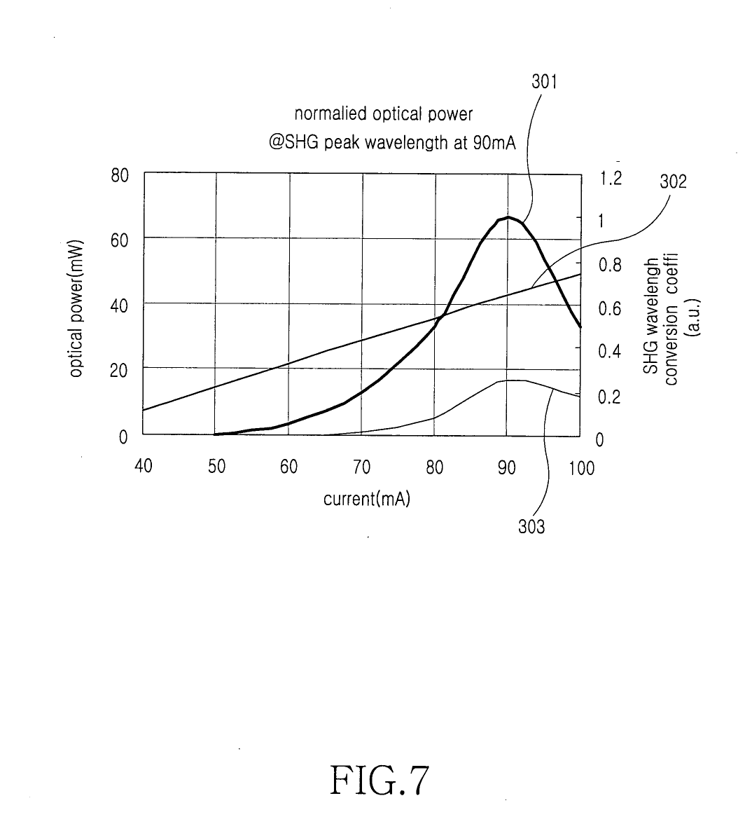

FIG. 7 is a graph for explaining the relationship between the operational characteristic of the second-harmonic generator 150 and current applied to a semiconductor laser 130. The Gaussian curve 301 shown in FIG. 7 corresponds to the characteristic curve of the second-harmonic generator 150. It can be understood, from FIG. 7, that a semiconductor laser driven with a current of about 90 milliamps (mA) presents the maximum wavelength conversion efficiency of 1 angstrom unit (a.u.), i.e., one ten billionth of a meter. Also, it can be understood that a curve 302 of current applied to the semiconductor laser and the Gaussian curve 301 are overlapped with each other within a range of about 80 mA to 100 mA, and the characteristic curve 303 of a light converted by the second-harmonic generator has a relatively superior efficiency when current of 80 mA to 100 mA is applied.

Different currents are applied to the first to fourth radiators 131 to 134 depending on gray scale levels established for the radiators, so that lights output from the radiators may have different wavelengths. Therefore, when the wavelength of a light—being a criterion for the conversion operation of the second-harmonic generator 150—is determined in the light source 100 for wavelength conversion, currents applied to the first to fourth radiators 131 to 134 are selected within an optimum range (a range of greater than 80 mA and less than 100 mA) of the Gaussian curve 301 shown in FIG. 7. Accordingly, although there is a difference among the wavelengths of the lights generated from the first to fourth radiators 131 to 134, the second-harmonic generator 150 can perform a wavelength conversion operation within a permitted range.

In particular, currents to be applied to the first to fourth radiators 131 to 134 of the semiconductor laser 130 are controlled such that the currents have values within the optimum range of the Gaussian curve of the second-harmonic generator 150, thereby obtaining the maximum conversion efficiency. The current to be applied to the radiators 131 to 134 may be adjusted according to the construction of the light source 100 for wavelength conversion.

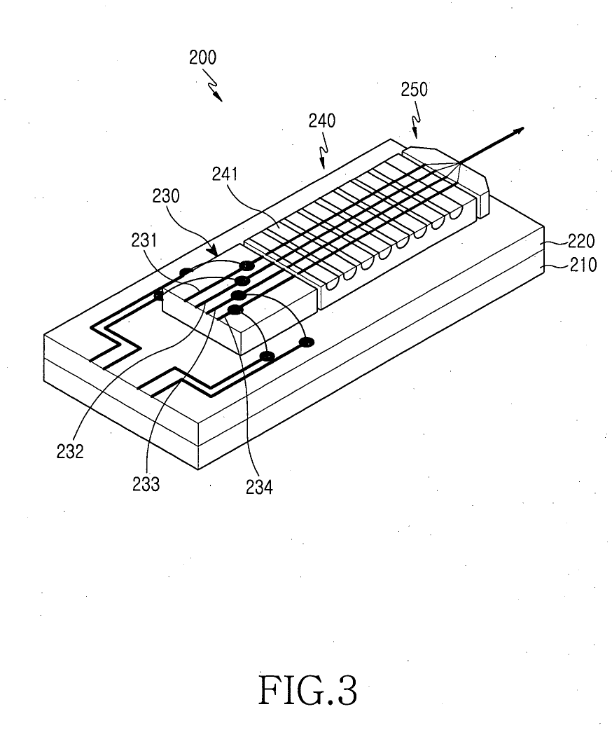

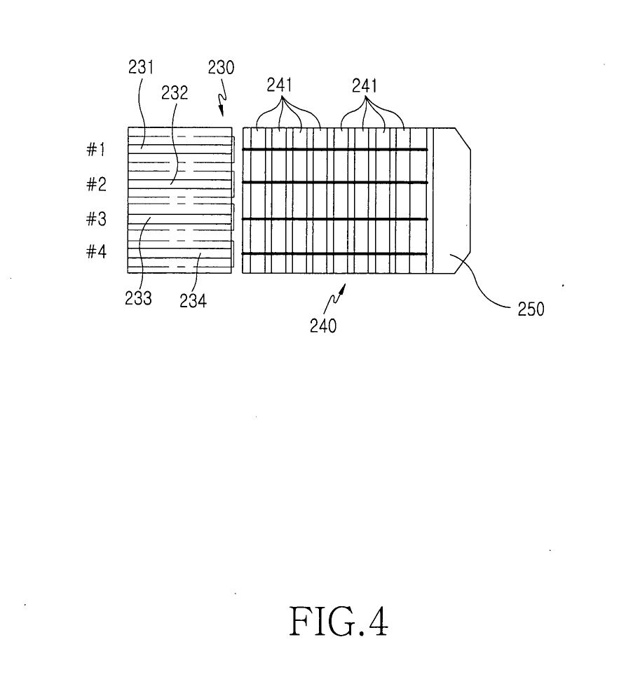

FIG. 3 depicts a light source for wavelength conversion according to a second embodiment of the present invention, and FIG. 4 is a top view of the FIG. 3 embodiment.

The second embodiment differs from the first in that the optical system is preferably implemented with a lens for converging light.

Referring to FIGS. 3 and 4, the light source 200 for wavelength conversion includes a semiconductor laser 230, a second-harmonic generator 240, and an optical system 250. The semiconductor laser 230 includes at least two radiators 231 to 234, to which different gray scale levels are allocated. The second-harmonic generator 240 performs an wavelength conversion operation with respect to each light radiated from each radiator 231, 232, 233, 234, and outputs the wave-converted lights. The optical system 250 is extended from the second-harmonic generator 240.

The light source 200 for wavelength conversion is constructed such that the semiconductor laser 230, second-harmonic generator 240 and optical system 250 are disposed on a sub-mount 220 mounted on a cooling unit 210.

The optical system 250 may include a lens for converging, into a single light beam, lights having different gray scale levels, which have been subjected to wavelength conversion by the second-harmonic generator 240. The lens outputs the converged light.

According to the present invention as described above, desired gray scale is advantageously achieved through combination of lights generated from the radiators 231 to 234, thereby preventing current from being rapidly changed during a converting operation and preventing chirp from occurring due to the rapid change of current.

In addition, because the present invention provides the light source for wavelength conversion using the semiconductor laser which includes a plurality of radiators having different gray scale levels, a direct modulation scheme can be utilized to control gray scale.

Also, the light source for wavelength conversion according to the present invention controls gray scale through combination of lights generated from the radiators, rather than through a change in the driving current to be applied to the semiconductor laser. Accordingly, possible damage to the semiconductor laser as a result of rapid change in current is avoided and the lifetime of the laser is preserved.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A wavelength-converting light source configured for controlling gray scale, said light source comprising:
a semiconductor laser including at least two radiators, to which different gray scale levels are allocated; and
a second-harmonic generator configured for performing wavelength conversion with respect to light beams radiated from the radiators, and outputting the wavelength-converted light beams.

2. The light source for wavelength conversion as claimed in claim 1, further comprising an optical system for converging light beams having different, respective gray scale levels.

3. The light source for wavelength conversion as claimed in claim 2, wherein the light beams to be converged are the outputted wavelength-converted light beams.

4. The light source for wavelength conversion as claimed in claim 3, wherein said converging is such as to converge into a single light beam for output from the light source.

5. The light source for wavelength conversion as claimed in claim 2, wherein the optical system comprises a waveguide portion, said portion including input ports corresponding one-to-one with the radiators and one output port connected to the input ports.

6. The light source for wavelength conversion as claimed in claim 2, wherein the optical system comprises a lens for said converging.

7. The light source for wavelength conversion as claimed in claim 1, wherein said laser is configured such that said at least two radiators amount to a number of radiators that depends upon how many different gray scale levels the light source is configured to output.

8. The light source for wavelength conversion as claimed in claim 7, wherein said number of radiators is defined based on the base two logarithm of said number of different gray scale levels for output.

9. The light source for wavelength conversion as claimed in claim 8, wherein said number of radiators is equal to the base two logarithm of said number of different gray scale levels for output.

10. The light source for wavelength conversion as claimed in claim 1, wherein said laser is configured such that combinations of radiators from among said at least two radiators uniquely correspond a particular gray scale levels.

11. The light source for wavelength conversion as claimed in claim 10, wherein a level from among said particular gray scale levels is additively composed of gray scale levels of light radiated by those of said at least two radiators that are currently radiating.

12. The light source for wavelength conversion as claimed in claim 11, communicatively connected with a display screen having a pixel driven to selectively display based upon said level from among said particular gray scale levels.

13. The light source for wavelength conversion as claimed in claim 10, communicatively connected with a display screen having a pixel driven to selectively display based upon said level from among said particular gray scale levels.

14. The light source for wavelength conversion as claimed in claim 1, wherein said laser is configured such that any arbitrary combination of radiators from among said at least two radiators uniquely correspond to a respective gray scale level.

15. The light source for wavelength conversion as claimed in claim 1, wherein the second-harmonic generator comprises a polarization-reversal region.

16. The light source for wavelength conversion as claimed in claim 15, wherein the second-harmonic generator comprises a plurality of polarization-reversal regions.

17. A modulating light source for wavelength conversion comprising the light source as claimed in claim 1 and a modulation circuit, wherein the radiators are connected to said modulation circuit for operating according to a digital scheme based on predetermined current.

18. The modulating light source for wavelength conversion as claimed in claim 17, further comprising an optical system for converging light beams having different, respective gray scale levels.

19. The modulating light source for wavelength conversion as claimed in claim 18, wherein the light beams to be converged are the outputted wavelength-converted light beams.

20. The modulating light source for wavelength conversion as claimed in claim 18, wherein said converging is such as to converge into a single light beam for output from the light source.
